(19) United States
(12) Patent Application Publication
(10) Pub. No.: US 2026/0201933 A1
(43) Pub. Date: Jul. 16, 2026

(54) ELECTROMECHANICAL BRAKING MECHANISM FOR A MOTOR VEHICLE

(71) Applicants: thyssenkrupp Presta AG, Eschen (LI); thyssenkrupp AG, Essen (DE)

(72) Inventors: Barna SZIMANDL, Gams (CH); Dennis PONGRATZ, Koblach (AT); Jan SLATINSKY, Buchs (CH)

(73) Assignees: thyssenkrupp Presta AG, Eschen (LI); thyssenkrupp AG, Essen (DE)

(21) Appl. No.: 19/136,457

(22) PCT Filed: Oct. 24, 2023
(86) PCT No.: PCT/EP2023/079650

§ 371 Date: Jun. 6, 2025

(30) Foreign Application Priority Data
Dec. 8, 2022 (BE) BE 2022/5999
Mar. 7, 2023 (BE) BE 2023/5167

(51) Int. Cl. F16D 65/56; B60T 13/74; F16D 55/225; F16D 65/18; F16D 65/38; F16D 121/24; F16D 125/36; F16D 125/40; F16D 125/48

(52) U.S. Cl. CPC F16D 65/567; B60T 13/746; F16D 55/225; F16D 65/18; B60T 2270/402; F16D 2065/386; F16D 2121/24; F16D 2125/36; F16D 2125/40; F16D 2125/48

(57) ABSTRACT

An electromechanical brake apparatus for a motor vehicle comprises an adjustment apparatus and a brake component which is connected thereto and which can be adjusted by the adjustment apparatus along an axis and brought into braking engagement with a counter-brake component, wherein the adjustment apparatus has a first actuator and a second actuator which is coupled thereto in series, wherein the first actuator has a rotatably drivable first drive wheel by which a first output element and a first drive element which can be adjusted axially relative thereto can be rotatably driven relative to each other, and the second actuator has a rotatably drivable second drive wheel which is coaxial relative to the first drive wheel and by which a threaded spindle which has a spindle thread which engages in an inner thread of the first actuator can be rotatably driven. In order to enable a more compact and less complex construction, the threaded spindle and the second drive wheel can have corresponding, mutually engaging positive-locking elements which are configured to produce a positive-locking connection which is effective with respect to rotation about the axis in a circumferential direction and which can be axially displaced relative to each other.

### PRIOR ART

The invention relates to an electromechanical brake apparatus for a motor vehicle, comprising an adjustment apparatus and a brake component which is connected thereto and which can be adjusted by the adjustment apparatus along an axis and brought into braking engagement with a counter-brake component, wherein the adjustment apparatus has a first actuator and a second actuator which is coupled thereto in series, wherein the first actuator has a rotatably drivable first drive wheel by which a first output element and a first drive element which can be adjusted axially relative thereto can be rotatably driven relative to each other, and the second actuator has a rotatably drivable second drive wheel which is coaxial relative to the first drive wheel and by which a threaded spindle which has a spindle thread which engages in an inner thread of the first actuator can be rotatably driven.

Such a brake apparatus of a motor vehicle is in the form of a friction brake in which a brake component which is supported on the chassis and which is fixed relative to the rotation of the wheel which is intended to be braked can be brought into braking engagement by means of an adjustment apparatus with a counter-brake component which rotates with the wheel. In braking engagement, a frictional contact between the brake component and counter-brake component is produced, wherein the brake torque produced by friction is greater the higher the adjustment force applied by the adjustment apparatus in the adjustment direction is.

A widespread construction type involves the disk brakes known in principle in which the counter-brake component is formed by means of a brake disk which rotates with the wheel and which is surrounded axially at both sides by a brake caliper. By means of at least one preferably linear actuator which is axially supported on the brake caliper, a brake component, generally a brake liner, can be adjusted in an axial adjustment direction and thereby be brought into frictional contact with an axial side of the brake disk, wherein the brake disk is clamped in a frictionally engaging manner in braking engagement between the adjusted brake component and another brake component which is supported in an axially opposing manner on the brake caliper.

The condition for correct function and a precise response of the brake is that, in the non-activated state between the brake component and the counter-brake component in the adjustment direction, a defined spacing, the so-called air gap, is provided. During the activation of the brake, the brake component is moved by the adjustment apparatus perpendicularly to the air gap toward the counter-brake component until the air gap is overcome and the frictional contact has been achieved so that the braking engagement is produced.

For a reproducible and precise response of the brake during travel operation, it is important that the air gap in the non-activated state measured in the axial adjustment direction has a defined gap width. The gap width may increase during operation, for example, as a result of wear of the brake liner, and must accordingly be re-adjusted. In order to adjust the air gap, it is known from EP 3 691 943 B1 that the adjustment apparatus has two actuators which are arranged in series in an adjustment direction. Each of the actuators has a drive-side drive element and an output-side output element which can be adjusted relative thereto in a linear manner in the axial adjustment direction. In order to produce an adjustment movement, each drive element has a drive wheel, preferably a gear wheel such as a toothed wheel or the like which can be rotatably driven about its axle by means of an electric actuator. The rotation of the drive wheel is in the actuator converted into a relative adjustment movement or an adjustment travel of the output element relative to the drive element in the axial adjustment direction. In the generic prior art, the two drive wheels of the first and second actuator are arranged coaxially on a common axle located in the axial adjustment direction.

An actuator forms in each case a travel or adjustment device which is effective in the adjustment direction, that is to say axially. The first actuator may, for example, comprise a ramp bearing, cam or curved disks, tilting pin arrangements or similar mechanisms which are configured to convert a rotation of the first drive element into a linear adjustment of the first output element. The second actuator has in the generic construction type a spindle drive having a threaded spindle which can be driven by the first drive element and which engages with the outer thread thereof in an inner thread of the first actuator. In the above-mentioned EP 3 691 943 B1, the axially fixedly supported threaded spindle engages in an inner thread of the first drive element.

As a result of the fact that the drive element of the second actuator is coupled to the output element of the first actuator, and the brake element is fitted to the output element of the second actuator, as a result of an actuation of the first actuator the brake element can be adjusted in a linear manner together with the second actuator in order to produce the braking engagement. As a result of an adjustment of the second actuator, the air gap can be adjusted regardless of the actuation of the first actuator. The first actuator can consequently be operated continuously in the optimum working range.

Another advantage of the two coupled actuators is that a redundant configuration is possible. It is thus possible, for example, as a result of the second actuator which is used during normal operation only to adjust the air gap, in principle for the braking engagement to also be produced.

In order to adjust the air gap in the above-mentioned EP 3 691 943 B1, the entire first actuator including the driving and output element can be axially displaced by means of the spindle drive of the second actuator. In order to enable the transmission of the drive torque of the first actuator, the first drive element is coupled to the first drive wheel in a torque-conducting and axially displaceable manner. To this end, there are provided positive-locking elements which protrude radially outwardly from the drive element and which are axially guided in axial guides in a tubular attachment which is arranged on the first drive wheel and in this instance produce a positive-locking connection which is active in a circumferential direction in order to transmit the drive torque. Although this arrangement provides the required functionality, it requires relatively great structural space. Furthermore, the production of a low-play axial guiding of the drive element is complex.

In view of the problems set out above, an object of the present invention is to enable a more compact and less complex construction.

### STATEMENT OF INVENTION

This object is achieved according to the invention by the braking apparatus having the features of claim 1. Advantageous further developments will be appreciated from the dependent claims.

With an electromechanical braking apparatus for a motor vehicle, comprising an adjustment apparatus and a brake component which is connected thereto and which can be adjusted by the adjustment apparatus along an axis and can be brought into braking engagement with a counter-brake component, wherein the adjustment apparatus has a first actuator and a second actuator which is coupled thereto in series, wherein the first actuator has a rotatably drivable first drive wheel by which a first output element and a first drive element which can be adjusted axially relative thereto can be rotatably driven relative to each other, and the second actuator has a second rotatably drivable drive wheel which is coaxial relative to the first drive wheel, by which a threaded spindle which has a spindle thread which engages in an inner thread of the first actuator can be rotatably driven, there is provision according to the invention for the threaded spindle and the second drive wheel to have corresponding, mutually engaging positive-locking elements which are configured to produce a positive-locking connection which is effective with respect to rotation about the axis in a circumferential direction and which can be axially displaced relative to each other.

The first and the second actuators are also referred to together below as actuators for short. The actuators have drive wheels which can be driven by means of electric drive motors about the axis, preferably toothed wheels, for example, spur gears. In the first actuator, via the first drive wheel the first drive element and the first output element can be rotatably driven relative to each other about the common axis so that, as a result of a travel or adjustment device, as described in the introduction, the drive and output element are axially adjusted relative to each other in an adjustment travel, wherein the terms “output-side” and “drive-side” are used in such a manner that they refer to the axially active direction of the actuator. The first adjustment device may, for example, comprise a ramp bearing, which is also referred to as a ball ramp arrangement, and may have as the drive and output element preferably curved disks with running tracks or ramps which are inclined with respect to the axis and between which balls which can roll in a circumferential direction are arranged. Alternatively, other known travel or adjustment mechanisms may be provided, for example, a wedge disk or tilting pin arrangement, a spindle drive or the like.

The drive wheels may in each case be in the form of a toothed wheel, for example, as a spur gear, or also a belt wheel or toothed belt wheel or worm gear so that generally a gear wheel is provided, via which a drive torque from one electric servo motor can be coupled into the actuator.

The second actuator is in the form of a spindle drive. It has a threaded spindle which can be rotatably driven by means of the second drive wheel and which is connected at the output side to the brake component, and which engages with the outer thread thereof, the spindle thread, in the inner thread of a spindle nut of the second drive element.

The spindle thread may preferably be configured to be self-limiting. This can be carried out by means of a relatively flat thread pitch which as a result of the active friction prevents a relative rotation of the threaded spindle and spindle nut even with high active axial forces. The adjustment of the air gap which is adjusted by the second actuator is thus maintained. Furthermore, as a result of the flat thread pitch, a particularly sensitive and precise adjustment of the air gap can be carried out.

In order to form the serial coupling of the actuators as described in the introduction, the spindle nut of the second drive element is preferably structurally joined to the first output element and may, for example, be in the form of an inner thread in a cam disk.

According to the invention the threaded spindle has a multiple function. Via the spindle thread, the active connection of the spindle drive is thus produced for axial adjustment. In addition, the drive function is integrated, according to which from the second drive wheel a drive torque can be coupled into the threaded spindle, wherein it can be axially displaced relative to the drive wheel. Specifically, there is an axial displacement together with the first output element with each activation of the first actuator in order to produce a braking engagement. The displaceability is produced according to the invention by means of mutually engaging positive-locking elements which produce a positive-locking connection which is effective with respect to rotation about the axis in the circumferential direction between the second drive wheel and threaded spindle so that a rotationally secure linear guiding is formed, via which the drive torque can be coupled. As a result of the fact that the positive-locking elements are configured with the positive-locking connection being maintained in a circumferential direction to be able to be displaced relative to each other in the axial direction, the rotating drive is also enabled even with the actuators which can be axially displaced relative to each other.

One advantage of the invention is that, as a result of the integration of the axially displaceable drive function in the threaded spindle, a more compact structural form than in the prior art can be produced, wherein the spindle nut is guided axially outward. As a result of the smaller diameter of the threaded spindle in comparison with the spindle nut, the torques and forces which occur with the rotating drive and with an axial displacement can be absorbed better and with less play. This results in a higher rigidity and improved functionality.

It is advantageous for a positive-locking element to be arranged in the region of the spindle thread. As a result of the fact that the positive-locking element is formed within the cross section of the threaded spindle, the outer contour thereof can be maintained and is in particular not increased. Consequently, the structural space requirement compared with a spindle drive without the functionality according to the invention is practically not increased so that, in comparison with the prior art, a more compact construction is enabled.

There may preferably be provision for the positive-locking elements to comprise a carrier which protrudes radially inward from the second drive wheel and an axial groove in the spindle thread in which the carrier engages. The drive wheel has an axial passage through which the threaded spindle extends with the spindle thread thereof. At least one carrier may have a tooth, cam or similarly configured projection which protrudes radially inward in the passage. This projection engages radially from the outer side in such a manner in an axially linearly extending axial groove which is introduced externally in the region of the threaded spindle that a positive-locking connection which is active in the circumferential direction is produced between the drive wheel and threaded spindle. In this instance, between the tooth and the open groove cross section sufficient play is provided so that the carrier is guided so as to be able to be axially displaced in the axial groove. Such a drive and guiding arrangement may be produced in a structurally compact manner with little structural complexity and in an operationally reliable manner. For operation, it is further advantageous for a common lubrication of the thread and the positive-locking elements to be enabled, for example, by means of an enclosed lubricant grease store.

There may be provision for the axial groove to extend over the entire spindle thread. The axial groove may extend over the entire axial length through the thread turns of the spindle thread so that a rotationally secure linear guiding over the entire length of the threaded spindle may be provided. As a result, an adequate adjustment range for adjusting the second actuator can advantageously be provided via the first adjustment unit.

It is advantageous for the axial groove to be formed radially deeper in the threaded spindle than the thread turns of the spindle thread. As a result of the fact that the axial groove is introduced externally deeper into the threaded spindle than the circumferential threaded groove of the spindle thread, the positive-locking connection with the carrier can be configured to be more durable in the circumferential direction. The resulting smaller surface pressure in the positive-locking connection enables an improved sliding behavior in an axial direction. The loading of the thread tooth in a circumferential direction can thereby be further reduced.

Preferably, there may be provision for a plurality of positive-locking elements to be arranged in a state distributed over the circumference. For example, two or more carriers and corresponding axial grooves may be arranged in a state distributed over the circumference, preferably distributed in a uniform manner. An advantageous guiding which is symmetrical relative to the axis can thereby be produced, wherein the individual positive-locking elements are subject to less loading and accordingly a smaller construction type and a higher overall load-bearing capacity can be produced.

It is possible for the carrier to be formed integrally with the second drive wheel. The second drive wheel may, for example, have a gear which including a sprocket and a hub portion with the passage for the threaded spindle may be configured in one or multiple parts. For example, it may have a plastics material injection-molded component or a metal injection-molded component or be in the form of one on which one or more carriers can be formed integrally. An operationally reliable structure with low weight and a rational production and assembly are thereby enabled.

There may be provision for the inner thread to be formed in the first output element. As a result of the first output element of the first actuator, the spindle drive of the second actuator which is coupled thereto is axially adjustable as a whole. As a result of the first output element being in the form, for example, of a cam disk of a ramp bearing, wedge disk, tilting pin bearing or threaded spindle of the first actuator, with which the spindle nut of the second actuator is integrally formed, a particularly compact and operationally reliable construction type can be achieved.

It is possible for the first actuator to have a ball ramp bearing, a wedge disk arrangement or a tilting pin arrangement. With a ball ramp bearing which can also be referred to as a ramp bearing or ball ramp arrangement for short, the drive element and output element preferably have cam disks with running tracks which are inclined with respect to the axis or ramps between which balls which can be rolled in a circumferential direction are arranged. A relative rotation as a result of the balls rolling on the ramps leads to the output element being axially displaced relative to the drive element. Such an arrangement is structurally simple, robust and operationally reliable. Alternatively, a tilting pin arrangement known per se can be used, in which between the drive element and output element tilting pins are arranged in such a manner and supported in each case in the circumferential direction that in the event of a relative rotation they are more or less inclined relative to the axis depending on the rotation direction, whereby the spacing between the drive element and output element can also be adjusted, Alternatively, wedge disk arrangements, spindle drives or other suitable mechanisms which enable a conversion of a rotation into an axial adjustment can be used.

There may be provision for there to be arranged between the first drive wheel and the second drive wheel a coupling apparatus which is in the form of a friction coupling having a friction element which in coupling engagement can be connected to a counter-friction element in a frictionally engaging manner. The friction coupling comprises a friction element which is connected in a torque-transmitting manner to one of the drive wheels and a corresponding counter-friction element which is connected in a torque-transmitting manner to the other drive wheel in each case. The friction element may be moved with the counter-friction element in any relative angular position into frictionally engaging coupling engagement. In this instance, a purely non-positive-locking coupling is produced in contrast to the positive-locking latching connection in the prior art. The relative position of the drive wheels relative to each other can thereby be continuously predetermined, in contrast to the separate locking steps in the prior art. Accordingly, a uniform, continuous adjustment of the second actuator relative to the first actuator is enabled and a continuous adjustment of the air gap can be carried out. This is particularly advantageous with regard to a uniform tracking of the optimum working point of the braking apparatus with regard to the continuous wear of the brake component during operation, that is to say the continuous wear of the brake liner. Compared with the only gradual adjustment possibility in the prior art, a continuously improved response behavior of the brake apparatus can be produced and consequently an increased operational reliability and a higher level of operating comfort.

Another advantage compared with a locking coupling described in the prior art is that in order to activate and release the coupling apparatus substantially no axial relative movement between the coupling elements which are in coupling engagement is required, for example, between the drive wheels or locking elements which in order to produce and release the lockable positive-locking connection necessarily have to be moved relative to each other. In contrast, the pure non-positive-locking connection between the friction and counter-friction element according to the invention can simply be predetermined by the applied axial activation force, wherein the friction and counter-friction element do not have to be moved axially relative to each other. A simpler and more reliable structural configuration of the coupling apparatus is thereby enabled.

There may be provision for the friction coupling to have a coupling torque which can be predetermined in a defined manner. The coupling torque indicates the maximum differential torque which can be transmitted by the frictional engagement in the coupling engagement in a non-positive-locking manner between the friction element and counter-friction element. When the coupling torque is exceeded, the coupling apparatus slides through so that the two drive wheels are rotated relative to each other. An advantage in this instance is that the friction coupling according to the invention slides through continuously in a sliding manner so that an improved, uniform re-adjustment of the air gap is enabled. Furthermore, no axial deviation movements of the locking elements have to be structurally taken into consideration and absorbed, as in the known locking coupling.

It is advantageous for the friction element and the counter-friction element to be arranged coaxially. In this instance, the coaxial arrangement corresponds to the coaxial arrangement of the drive wheels. The friction element and the counter-friction element may be arranged in a structurally simple manner and in a compact configuration in the region of the axially oppositely directed end faces of the drive wheels. As a result of the above-described production of the pure non-positive-locking of the coupling, no movable components are required as in the locking coupling in the prior art.

In an advantageous embodiment, there may be provision for the friction element and the counter-friction element to be configured conically. The friction element may in this instance have a conical portion which tapers at least partially in the axial adjustment direction and which has a conical friction face which may be in the form of an outer cone or an inner cone and which works together with a corresponding conical portion on the counter-friction element which is accordingly configured in an opposing manner as an inner cone or outer cone and which has a conical counter-friction face. In order to produce the coupling engagement, the outer cone is introduced into the inner cone, wherein the conical friction and counter-friction faces are loaded in a frictionally engaging manner with respect to each other by an axial activation force of the coupling. An advantage in this instance is that, as a result of the cone, a force transmission of the axially active activation force of the coupling into the normal force acting between the conical friction faces with frictional contact can be carried out. Thus, as a result of a shallower inclination a relatively small activation force can be converted into a larger normal force, whereby, already as a result of a relatively small axial activation force of the coupling, a high coupling torque can be produced.

Alternatively or additionally to the above-mentioned embodiment, there may be provision for the friction element and the counter-friction element to be configured in a planar manner. In this instance, the mutually corresponding friction faces are at least partially in the form of planar axial faces, in a similar manner to a disk coupling. A space-saving arrangement is enabled, particularly when only a relatively small coupling torque is intended to be produced.

There may preferably be provision for the friction element and the counter-friction element to be pretensioned with respect to each other. Preferably, the friction element and the counter-friction element are resiliently or flexibly pretensioned with respect to each other. In this instance, the friction and counter-friction faces are pressed against each other with a predetermined axial pretensioning force in frictional engagement. In order to produce the pretensioning force a resilient pretensioning element may preferably be provided, for example, a resilient element or the like. The coupling torque of the friction coupling is determined by the activation force which acts perpendicularly to the friction contact, that is to say the force applied axially between the friction and counter-friction element, wherein the coupling torque is greater, the greater the pretensioning force is. This affords the advantageous possibility that the coupling torque can be simply predetermined by the pretensioning force applied by the pretensioning element. For example, with a compression-resilient resilient element in an axial direction, such as a pressure spring, the applied pretensioning force can be simply predetermined and adapted by the spring constant and the compression of the spring.

The above-mentioned embodiment may advantageously be produced by the friction element and/or the counter-friction element being axially displaceable and supported by means of an axially effective resilient element against the first drive wheel or the second drive wheel. The friction element or the counter-friction element are in this instance torque-transmitting and connected to one drive wheel in an axially displaceable manner, for example, by means of radially protruding carriers which produce a positive-locking connection which is active in a circumferential direction. The resilient element which is axially clamped between the friction element or the counter-friction element and one drive wheel and which is preferably in the form of an axially effective pressure spring ensures that the friction or counter-friction element is pressed axially against the corresponding counter-friction or friction element which is axially supported on the other drive wheel, that is to say is pressed axially in frictional contact against it. The corresponding counter-friction or friction element is connected in a rotationally secure manner to the other drive wheel in each case. It is also possible alternatively or additionally for the counter-friction element to be supported by means of a resilient element on one of the drive wheels. An advantage of this arrangement is that the friction coupling according to the invention can be incorporated in a structurally simple and structural-space-saving manner between the drive wheels.

In an advantageous further development, it is possible for the friction element and/or the counter-friction element to be arranged in the first drive wheel or the second drive wheel. It is thus, for example, possible for one drive wheel to be configured in a substantially drum-like manner so that the friction or counter-friction element can be arranged in an inner space which is surrounded by the rotating toothed wheel or sprocket. A compact structure which is protected from external influences is thereby enabled. It is thus possible, for example, for the drive wheel of the first actuator to have a conical friction element which engages axially in a counter-friction element which is in the form of an inner cone and which is arranged at least partially inside the second drive wheel.

A particularly compact structure may—in particular in the last-mentioned embodiment—be produced by the drive wheels being arranged inside the axial extent of the actuators, that is to say not being fitted so as to protrude axially at one side.

It is preferable for the friction element and/or the counter-friction element to have a friction liner. The friction and counter-friction element preferably have a metal base member, for example, made of steel. In order to avoid metal/metal contact, a coating or a liner may preferably be applied in order to produce a friction pairing with a defined friction force, for example, made of sintered, metal and/or ceramic friction materials, composite materials or the like. A defined, reproducible coupling torque can thereby be ensured.

There may be provision for an actuator to have a spindle drive. In this instance, a threaded spindle engages in a manner known per se in a spindle nut, and a relative rotating drive via a drive wheel which is connected to the threaded spindle or the spindle nut. It is possible for the spindle nut to form the drive-side drive element of the actuator and the threaded spindle to form the output-side output element which can be linearly adjusted relative thereto, or vice-versa.

It is possible for an actuator to have a ball ramp arrangement, wedge disk arrangement or a tilting pin arrangement. With a ball ramp arrangement, also referred to as a ramp bearing, the drive and output element preferably have cams with running tracks or ramps which are inclined relative to the axis and between which balls which roll in the circumferential direction are arranged. A relative rotation leads as a result of the balls which are rolling on the ramps in this instance to the output element being axially displaced relative to the drive element. With a tilting pin arrangement known per se, tilting pins are arranged between the drive and output element and supported in each case in the circumferential direction in such a manner that in the case of a relative rotation depending on the rotation direction they are more or less inclined relative to the axis, whereby the spacing between the drive and output element can also be adjusted.

In the adjustment apparatus, two identically acting actuators may be combined with each other as the first and second actuators, for example, two spindle drives. It is also possible to combine two different structures with each other, for example, a ball ramp arrangement as a first actuator and a spindle drive as a second actuator for adjusting the air gap. In this instance, the respective characteristic properties of each structure can be used in an optimum manner. For example, with a ball ramp arrangement with little complexity a non-linear adjustment characteristic can be produced, and/or at least partially self-limiting properties and/or a defined dead center position or extended position which enables a defined adjustment path. The implementation of the mentioned positive features may at least partially require a precise specification of the air gap which is not possible with the locking coupling in the prior art, but can be implemented in a problem-free manner with the friction coupling according to the invention.

In a method for operating an electromechanical braking apparatus which has an adjustment apparatus comprising a first actuator and an actuator which is coupled in series thereto, and which acts on a brake component which can be brought into braking engagement with a counter-brake component in the direction of an axis, wherein the first actuator has a rotatably drivable first drive wheel to which for actuation a first drive torque can be applied, and the second actuator has a rotatably drivable second drive wheel which is coaxial with respect to the first drive wheel and to which for actuation a second drive torque can be applied, wherein between the first drive wheel and the second drive wheel a coupling apparatus is arranged, there is provision according to the invention for the coupling apparatus to be in the form of a friction coupling and to have a predeterminable coupling torque which when exceeded causes the first drive wheel to slide through in a sliding manner relative to the second drive wheel, wherein in order to activate the first actuator the first drive wheel and the second drive wheel are synchronously driven so that the second actuator remains non-activated, and in order to activate the second actuator the second drive wheel is driven and the first drive wheel is stopped relative thereto so that the friction coupling slides through and the first actuator remains non-activated.

The features mentioned above in connection with the braking apparatus according to the invention can be used individually and in combinations in order to implement the method according to the invention.

In order to adjust the first actuator, by means of a first electric servo motor an adjustment torque can be coupled into the first drive wheel and accordingly the second actuator can be driven by a second electric servo motor.

During normal braking operation, the first and second drive wheels are rotated synchronously. This may, on the one hand, be carried out by the first and second drive wheels being driven by the first and second servo motors with synchronized drive torques. On the other hand, the second drive wheel can when driving the first drive wheel be carried synchronously by the coupling apparatus as long as the transmitted drive torque remains below the coupling torque. In this operating mode, the second actuator remains non-activated and rotates as a whole in an idle manner together with the brake element.

With the method according to the invention, the coupling apparatus can, when the coupling torque is exceeded in order to adjust the air gap in contrast to the prior art, slide through continuously and in a uniform sliding manner. This may, for example, be implemented by the drive wheel of the first actuator being determined, for example, by means of a brake or a corresponding control of the first drive motor, whilst a second drive torque which is greater than the coupling torque is applied to the second drive wheel by the second drive motor. The second drive wheel is thereby rotated relative to the first drive wheel and by activating the second actuator the air gap can be adjusted in a continuous and sensitive manner so that a continuously progressing wear of the brake element or the brake liner can be compensated for in an optimum manner.

It is possible for the first drive wheel and the second drive wheel to be coupled in a torque-transmitting manner in order to produce a synchronous driving by the friction coupling. In this instance, no synchronous driving of the two drive wheels by the servo motors is required. Any torque differences can be compensated for within predetermined tolerances.

There may advantageously be provision when the first actuator is activated for a higher coupling torque to be predetermined than when the second actuator is activated. The first actuator is activated by means of synchronous driving of the first and second drive wheels. The friction element and the counter-friction element are pretensioned with respect to each other by the resilient force of the resilient element and in addition the adjustment force of the first actuator acts counter to the resilient force. A relatively high coupling torque is thereby achieved. If in contrast in order to adjust the air gap only the second drive wheel is rotated, only the resilient force acts so that a lower coupling torque is adjusted. The adjustment of the air gap is thereby facilitated.

### DESCRIPTION OF THE DRAWINGS

Advantageous embodiments of the invention will be explained in greater detail below with reference to the drawings, in which:

FIG. 1 shows a brake apparatus according to the invention as a schematic, perspective view,

FIG. 2 shows a lateral view of the brake apparatus according to FIG. 1,

FIG. 3 shows the adjustment apparatus according to the invention of the brake apparatus according to FIG. 1 in a detached state as a schematic, perspective view,

FIG. 4 shows a section Q-Q through the brake apparatus according to FIG. 1,

FIG. 5 shows the first actuator of the brake apparatus according to FIG. 1 in a detached state as a schematic, perspective illustration,

FIG. 6 shows an enlarged detailed view of the adjustment apparatus from FIG. 4,

FIG. 7 shows the actuators of the adjustment apparatus according to FIG. 4 as a schematically axially exploded illustration,

FIG. 8 shows an enlarged partial illustration of the second actuator from FIG. 7.

### EMBODIMENTS OF THE INVENTION

In the different figures, identical components are always given the same reference numerals and are therefore generally also only named or mentioned once in each case.

FIG. 1 shows a brake apparatus according to the invention as a whole which is in the form of a disk brake. It comprises a brake disk 2, which forms a counter-brake component in the context of the invention and is connected to a vehicle wheel which is not illustrated in this instance and which can be rotated about a wheel axle R. A brake caliper 3 surrounds the two axial end faces of the brake disk 2.

The brake disk 2 is in this instance in the form of a non-ventilated brake disk made of solid material. Alternatively, it can also be in the form of an internally ventilated brake disk.

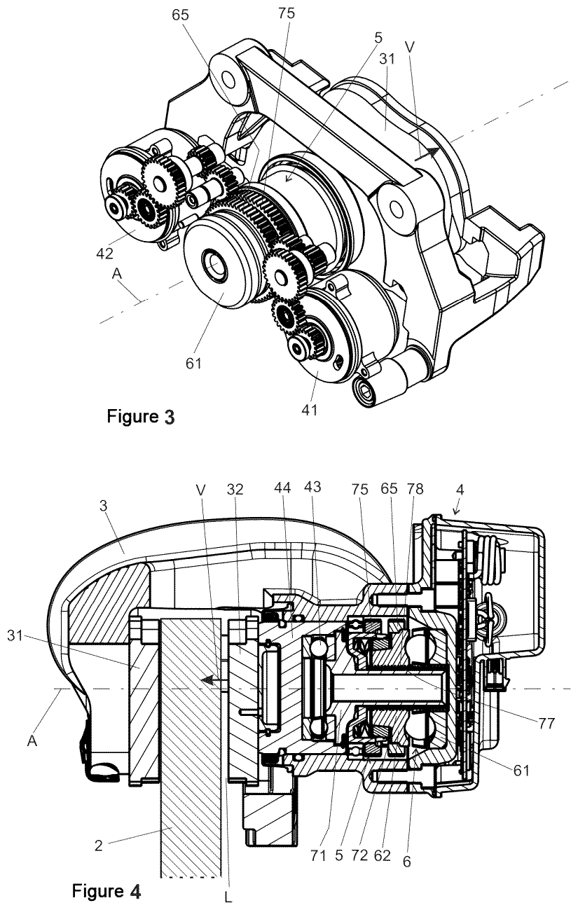

There is fitted on the brake caliper 3 an electric brake actuator 4 according to the invention which is shown in FIG. 3 in a separate, detached, schematic, perspective view and is explained in detail in FIGS. 4 to 7.

The brake actuator 4 comprises an adjustment apparatus 5 which extends axially in the direction of an axis A, which is located parallel with the wheel axle R and which indicates the axial adjustment direction V of the actuation apparatus 5.

As can be seen in the sectioned illustration of FIG. 4 along the axis A, the brake disk 2 is arranged axially between two brake liners 31 and 32. The first brake liner 31 is securely supported on the brake caliper 3 at the side remote from the brake actuator 4. The other brake liner 32 which forms a brake component in the context of the invention is fitted to the adjustment apparatus 5 and can be adjusted by this in the axial adjustment direction V determined by the axis A in order to produce the braking engagement toward the brake disk 2, as indicated by the arrow in FIG. 4.

In the non-activated state of the brake apparatus 1, there is between the brake disk 2 and the adjustable brake liner 32 an axial air gap L which is schematically illustrated in FIG. 4 to an excessively wide scale.

The construction of the adjustment apparatus 5 is illustrated in FIG. 4 and in the enlarged cut-out thereof in FIG. 6.

The adjustment apparatus 5 comprises a first actuator 6 which has a ramp bearing, and a second actuator 7 which is axially (with respect to the axis A) coupled thereto in series and which has a spindle drive.

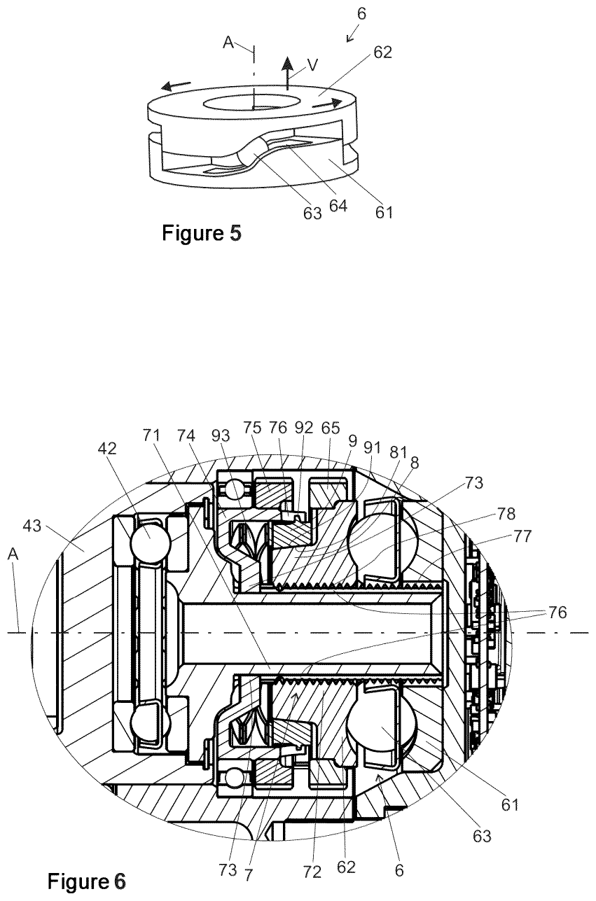

The first actuator 6 which in the example shown is in the form of a ramp bearing, comprises a drive-side cam disk 61 which is supported axially and in a rotationally secure manner on the brake actuator 4 and an output-side cam disk 62. Balls 63 are arranged between the cam disks 61 and 62. As can be seen in the schematically detached view of FIG. 5, the cam disks 61 and 62 have axially mutually opposing ramp-like running tracks 64 which are located obliquely with respect to the axis A and between which the balls 63 can roll. A rotation of the output-side cam disk 62, in FIG. 5 at the top, relative to the fixed drive-side cam disk 61—as indicated schematically with the curved arrows—leads to a linear displacement of the output-side cam disk 62 in the adjustment direction V parallel with the axis A. The brake liner 32 can thereby, as indicated in FIG. 4, be moved into braking engagement by activating the first actuator 6.

The cam disk 62 is connected to a coaxial toothed wheel 65 which is in the form of a spur gear and forms a drive wheel in the context of the invention.

The toothed wheel 65 is in meshing engagement with a first electric servo motor 41. This enables the rotating driving of the cam disk 62 and consequently an activation of the first actuator 6.

The second actuator 7, which according to the invention is in the form of a spindle drive, has at the output side a threaded spindle 71 which with the outer thread 77 thereof, also referred to as the spindle thread, engages in the inner thread 78 of a drive-side spindle nut 72. This inner thread 78 is configured to be integrated in the cam disk 62 of the first actuator 6 so that the functions of the output-side cam disk 62 and of the drive-side spindle nut 72 are combined in one structural element.

The threaded spindle 71 is connected by means of a hub portion 74 to a coaxial toothed wheel 75 which is rotatably supported in an axially fixed manner in the brake actuator 4.

The threaded spindle 71 is axially guided through an axial passage in the toothed wheel 75, specifically in the hub portion 74. In the passage, the radially inwardly protruding carriers 73 which, for example, may have radially protruding projections or teeth are provided. The carriers 73 engage radially from the outer side in axial grooves 76 in the threaded spindle 71, which are also referred to as slots, in order to form a positive-locking connection which is active in the circumferential direction and can be axially displaced in the axial grooves 76. The threaded spindle 71 is thereby coupled to the toothed wheel 75 so as to transmit torque and so as to be able to be axially displaced.

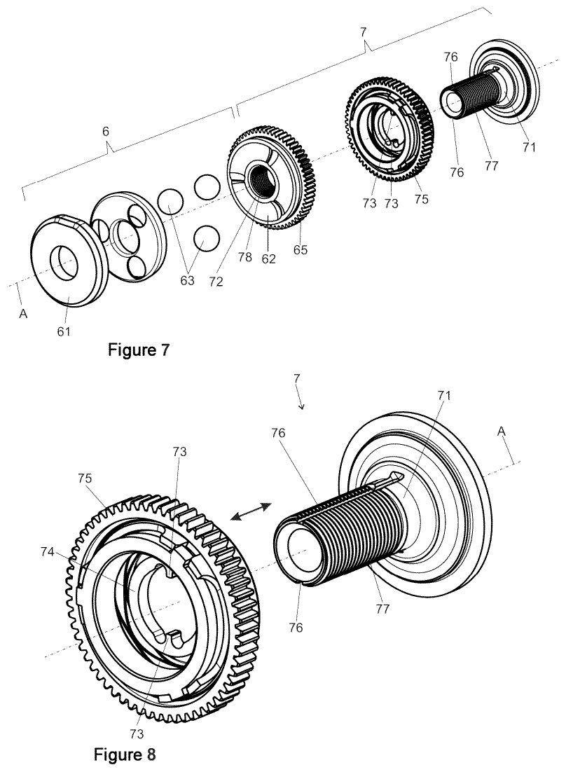

FIG. 7 shows the functional elements of the actuators 6 and 7 in a schematically exploded illustration in the direction of the axis A, and FIG. 8 shows the threaded spindle 71 and the toothed wheel 75 of the second spindle drive 7 in an enlarged view of FIG. 7. The threaded spindle 71 has the outer thread (spindle thread) 77 which engages in the corresponding inner thread 78 of the spindle nut 72. The spindle nut 72 is preferably configured to be integrated with the cam disk 62 of the first actuator 6.

The threaded spindle 71 has in the example two axial grooves 76 which are distributed in a mutually opposed state symmetrically over the circumference and extend over the entire length of the outer thread 77. The axial grooves 76 may preferably be formed to be radially deeper than the threaded groove of the outer thread 77.

In the axial passage of the toothed wheel 75, there are arranged two radially inwardly protruding carriers 73 which in order to form a rotationally secure connection can engage in the axial grooves 76 and in this instance are axially displaceable, as indicated in FIG. 8 with the double-headed arrow.

The carriers 73 may be formed integrally on the hub portion 74 or the toothed wheel 75, for example, on an injection-molded component made of plastics material or a metal die-cast component.

The toothed wheel 75 may in the same manner as the toothed wheel 65 be in the form of a spur gear and is arranged coaxially adjacent thereto. This toothed wheel 75 is in meshing engagement with a second electrical actuator 42. This enables the rotating driving of the threaded spindle 71 and consequently an activation of the second actuator 7.

The threaded spindle 71 is axially connected by means of a pressure bearing 43, for example, as illustrated an axial roller bearing, to a pressure piece 44, to which the displaceable brake liner 32 is fitted, as can be seen in FIG. 4. The pressure piece 44 may also be referred to as a piston.

Optionally, a coupling apparatus may be provided. The configuration of the second actuator 7 according to the invention may also be produced without such a coupling apparatus.

The coupling apparatus has a friction element 8 which is directed as a coaxial, conical attachment from the cam disk 62 in the direction toward the second actuator 7. The conical attachment has a conical friction face 81 which is arranged externally on an outer cone. The friction element 81 may preferably be configured integrally with the cam disk 62/spindle nut 72.

The friction element 8 is coupled in coupling engagement with a counter-friction element 9 in a frictionally engaging manner. In this instance, the conical attachment is introduced axially into a corresponding conical opening of the counter-friction element 9 which has a conical friction face 91 which is arranged in an inner cone. In coupling engagement, the friction face 81 and the counter-friction face 91 bear in a frictionally engaging manner on each other, as can be clearly seen in FIG. 6.

The counter-friction element 9 is coupled by means of carriers 92, which engage in an axially displaceable manner in corresponding slots 76 in the hub portion 74 or the toothed wheel 75, to the toothed wheel 75 in a torque-transmitting but axially displaceable manner.

A resilient element 93 is arranged between the toothed wheel 75, or the hub portion 74 which is connected thereto, and the counter-friction element 9. As a result of the axially effective resilient force thereof, the counter-friction element 9 is resiliently tensioned with respect to the friction element 8. A defined coupling torque of the friction coupling according to the invention formed by the friction element 8 and the counter-friction element 9 is thereby produced.

In order to activate the brake apparatus 1, the toothed wheels 65 and 75 are rotated synchronously so that the first actuator 6 carries out working travel in the axial adjustment direction V so that the brake liner 32 passes the air gap L and moves into braking engagement with the brake disk 2. The synchronous driving of the toothed wheels 65 and 75 can be implemented by means of a synchronization of the drive speeds of the servo motors 41 and 42, or by driving using only one of the servo motors 41 or 42, whilst the other servo motor 42 or 41 runs in an idle manner in each case. The frictionally engaging coupling engagement between the friction element 8 and the counter-friction element 9 then ensures a synchronous rotation of the toothed wheels 65 and 75.

In order to adjust the width of the air gap L, the toothed wheel 65 is secured or blocked, for example, by means of a corresponding control of the first servo motor 41. By means of the second servo motor 42, the toothed wheel 75 is rotated relative to the toothed wheel 65, wherein the friction coupling slides through continuously in a sliding manner. Accordingly, the second actuator 7 is adjusted in a uniform manner, whereby the width of the air gap L can also be continuously adjusted and adapted in order, for example, to compensate for wear of the brake liner 32.

As a result of the fact that the friction element 8 and the counter-friction element 9 are arranged completely or at least partially inside the toothed wheels 65 and 75, a particularly compact structure can be produced.

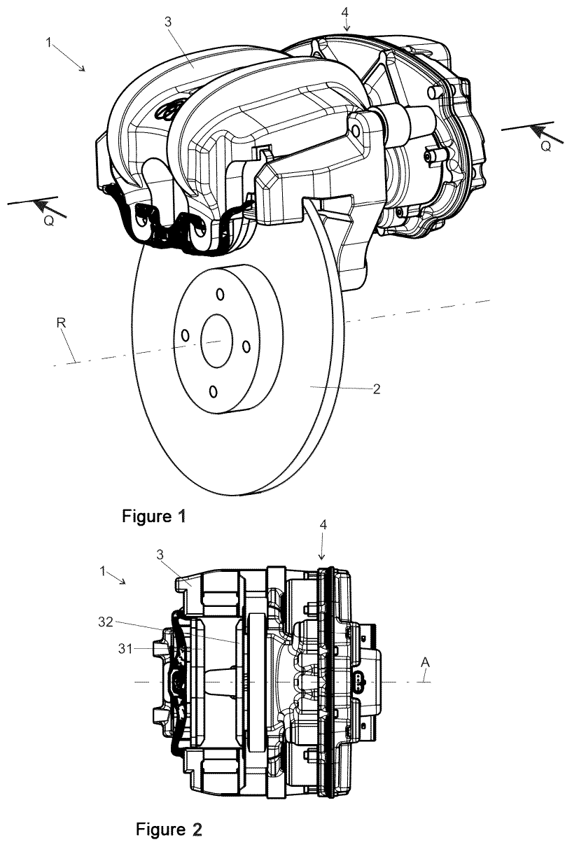

The brake apparatuses illustrated in FIGS. 1 to 6 are in the form of floating caliper brakes which are also referred to as sliding caliper brakes. In this instance the brake liner 32 is pressed by the pressure piece 44, and the brake liner 31 is pressed by the brake caliper 3 which can be displaced with respect to the brake disk 2 in the direction of the axis A onto the brake disk 2. Alternatively, the solution according to the invention may also be used with a fixed caliper brake.

### List of Reference Numerals

1 Brake apparatus
2 Brake disk
3 Brake caliper
31, 32 Brake liner
4 Brake actuator
41, 42 Servo motor
43 Pressure bearing
44 Pressure piece
5 Adjustment apparatus
6 First actuator
61 Cam disk
62 Cam disk (integrated with spindle nut 72)
63 Ball
64 Running track
65 Toothed wheel
7 Second actuator
71 Threaded spindle
72 Spindle nut (integrated with cam disk 62)
73 Carrier
74 Hub portion
75 Toothed wheel
76 Axial groove (slot)
77 Outer thread (spindle thread)
78 Inner thread
8 Friction element
81 Friction face
9 Counter-friction element
91 Counter-friction face
92 Carrier
93 Resilient element
A Axis
R Wheel axle
V Adjustment direction
L Air gap

1-15. (canceled)

16. An electromechanical brake apparatus for a motor vehicle, comprising:
an adjustment apparatus; and
a brake component connected to the adjustment apparatus and which can be adjusted by the adjustment apparatus along an axis and brought into braking engagement with a counter-brake component;
wherein the adjustment apparatus has a first actuator and a second actuator which is coupled to the first actuator in series;
wherein the first actuator has a rotatably drivable first drive wheel by which a first output element and a first drive element which can be adjusted axially relative thereto can be rotatably driven relative to each other, and the second actuator has a rotatably drivable second drive wheel which is coaxial relative to the first drive wheel and by which a threaded spindle which has a spindle thread which engages in an inner thread of the first actuator can be rotatably driven;
wherein the threaded spindle and the second drive wheel have corresponding, mutually engaging positive-locking elements which are configured to produce a positive-locking connection which is effective with respect to rotation about the axis in a circumferential direction and which can be axially displaced relative to each other.

17. The brake apparatus as claimed in claim 16, wherein a positive-locking element is arranged in the region of the spindle thread.

18. The brake apparatus as claimed in claim 16, wherein the positive-locking elements comprise a carrier which protrudes radially inward from the second drive wheel and an axial groove in the spindle thread in which the carrier engages.

19. The brake apparatus as claimed in claim 18, wherein the axial groove extends over the entire spindle thread.

20. The brake apparatus as claimed in claim 18, wherein the axial groove is formed radially deeper in the threaded spindle than the thread turns of the spindle thread.

21. The brake apparatus as claimed in claim 16, wherein a plurality of positive-locking elements are arranged in a state distributed over the circumference.

22. The brake apparatus as claimed in claim 18, wherein the carrier is formed integrally with the second drive wheel.

23. The brake apparatus as claimed in claim 16, wherein the inner thread is formed in the first output element.

24. The brake apparatus as claimed in claim 16, wherein the first actuator has a ball ramp bearing, a wedge disk arrangement or a tilting pin arrangement.

25. The brake apparatus as claimed in claim 16, wherein there is arranged between the first drive wheel and the second drive wheel a coupling apparatus which is in the form of a friction coupling having a friction element which in coupling engagement can be connected to a counter-friction element in a frictionally engaging manner.

26. The brake apparatus as claimed in claim 25, wherein the friction coupling has a coupling torque which can be predetermined in a defined manner.

27. The brake apparatus as claimed in claim 15, wherein the friction element and the counter-friction element are arranged coaxially.

28. The brake apparatus as claimed in claim 25, wherein the friction element and the counter-friction element are configured conically.

29. The brake apparatus as claimed in claim 25, wherein the friction element and the counter-friction element are configured in a planar manner.

30. The brake apparatus as claimed in claim 25, wherein the friction element and the counter-friction element are pretensioned with respect to each other.
